(19) United States
(12) Patent Application Publication
(10) Pub. No.: US 2008/0279563 A1
(43) Pub. Date: Nov. 13, 2008

(54) Apparatus and Method for Self-Adaptive Dispersion Compensating

(76) Inventor: Huade Shu, Guangdong Province (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/096,809

(22) PCT Filed: Dec. 20, 2005
(86) PCT No.: PCT/CN2005/002249

§ 371 Date: Jun. 10, 2008

(51) Int. Cl. H04B 10/12

(52) U.S. Cl. 398/147

(57) ABSTRACT

An apparatus for adaptive dispersion compensation and the method thereof applied to adaptive dispersion compensation in an optical communication system comprises: input optical fiber, an optical tunable dispersion compensator, output optical fiber, a signaling system unit, a control logic unit which is used to calculate the adjustment value of the optical tunable dispersion compensator according to the dispersion performance information detected by the signaling system unit, then control the optical tunable dispersion compensator through feedback, thus adjust the dispersion compensation value of the optical dispersion compensator. The present invention overcomes the deficiency of the prior art by adaptively compensating the system dispersion in real time, thus the transmission quality of the system signal is effectively guaranteed, and in the case that the dispersion of the lines or optical network nodes varies, it can implement the adaptive dispersion compensating for multi-channel or single-channel system.

### TECHNICAL FIELD

The present invention relates to the field of optical transmission system, and more specifically to an apparatus for adaptive dispersion compensation and the method thereof.

### TECHNOLOGY BACKGROUND

With rapid development of the optical communication technology, the optical communication system develops toward the direction of high speed, large capacity, long distance and intelligence. Nowadays, Dense Wavelength Division Multiplexing (DWDM) optical communication system with 160 channels and, 10 Gb/s single-channel speed, as well as the Automatically Switched Optical Network (ASON) system based on intelligent circuit switching has also been commercially applied. In the future, optical network systems with larger capacity and higher speed (40 Gb/s or above) and intelligent optical network systems having the function of Optical Cross Connect (OXC) or Reconfigurable Optical Add/Drop Multiplexer (ROADM) will appear.

In ultra-high speed optical transmission system, dispersion and polarization mode dispersion (PMD) deteriorate the optical signal quality and reduce the transmission distance. In order to increase the transmission distance of the optical transmission system, measures should be taken to compensate the dispersion and PMD. In the conventional optical communication system, fixed dispersion compensators are often applied to compensate the dispersion in the optical transmission line, and FIG. 1 is the block diagram of dispersion compensation means for the conventional optical communication system. Due to dispersion compensation, the residual dispersion of the optical signals at the receiving side can be controlled within the range of which the receiver can tolerate. The dispersion compensator is generally implemented by the dispersion compensation optical fiber module which can be placed in the optical terminal station as well as the optical regeneration station. In the optical terminal station, the dispersion compensation module is generally used to perform dispersion compensation for multi-channel optical signals in DWDM system before wavelength multiplexing and after wavelength de-multiplexing. In the optical regeneration station, two-stage optical amplifier structure is mostly applied and the dispersion compensation optical fiber module can be placed between the two-stage amplifiers to implement the multi-channel dispersion compensation.

For long-distance optical transmission system, factors such as temperature and pressure can cause small variation of the dispersion coefficient of the optical fiber line, thus the real-time change of dispersion of the optical signal in the line will continually accumulate along with the increase of the total transmission distance, which probably causes the residual dispersion of the signal at the receiving side exceeds the tolerable range and deteriorates the bit error performance of the system.

With the increase of the single-channel transmission speed, the dispersion tolerance of the optical source will decrease. The dispersion tolerance is about 1000 ps/nm for the 10 Gb/s optical signal without pre-chirp, and about 40 ps/nm for 40 Gb/s optical signal without pre-chirp, which is only equivalent to 2 km transmission distance of 1550 nm window of G.652 optical fiber. Therefore, we can say that for 40 Gb/s system, since the dispersion tolerance of the optical source is relatively small, any small changes of the dispersion of the optical fiber line can cause the residual dispersion of the signal at the receiving side to exceed the tolerable range and deteriorate the bit error performance of the system. The influence of the change of the fiber dispersion is especially evident for the performance of the 40 Gb/s system.

On the other side, with the development of the intelligent optical network, ROADM and even OXC nodes may be introduced into the optical network. In these optical network nodes, dynamic add/drop multiplexing and dynamic cross connecting of the optical signal can cause the changes of the dispersion of the optical line through which the optical signal transmits, thus causing the residual dispersion of the signal at the receiving side to exceed the tolerable range and deteriorate the bit error performance of the system.

In a word, the above factors indicate that with the development of the optical network in the direction of high speed, long distance and intelligence, the residual dispersion of the signal at the receiving side will continually change due to the variation of the dispersion of the line and the optical network nodes after the optical signal are transmitted through the line. It is necessary to perform adaptive dispersion compensation for these signals whose residual dispersion continually changes, how to achieve the adaptive dispersion compensation is a key problem in the technical field.

The adaptive dispersion compensation of the optical transmission system can be optically or electrically implemented by the tunable dispersion compensator.

There are many methods to achieve electrical dispersion compensation. As shown in FIG. 2 which is a schematic block diagram of the receiver with the capability of electrical dispersion compensation, after the optical signal is photoelectrical converted and linear amplified, it is sent to the equalization circuit. Using some control strategy and the performance of the feedback control equalizer, checking the quality of the electrical signal after equalized, the adaptive dispersion compensation can be realized. The feature of this method is that the implementation method is simple and the response is fast, yet the range of dispersion compensation is narrow and only single-channel dispersion compensation can be implemented. The equalization circuit applied for electrical dispersion compensation can be Feed-forward Equalizer (FFE), Decision Feedback Equalizer (DFE), Fixed Delay Tree Search (FDTS) or Maximum Likelihood Sequence Estimation (MLSE), or their combinations. For the electrical dispersion compensation technology, the dispersion value to be compensated is generally small. For example, for 10 Gb/s signal, the electrical dispersion compensation equals to increasing 20˜40 km transmission distance in G.652 optical fiber.

FIG. 3 is a schematic block diagram of applying optical tunable dispersion compensator to implement adaptive dispersion compensation, the adaptive dispersion compensation function can be implemented by detecting the residual dispersion of the system, or the bit error performance of the system to control the dispersion compensation quantity of the tunable dispersion compensator through feedback. There are many methods for implementing the optical tunable dispersion compensation, including methods applying chirped fiber Bragg grating (CFBG) technology, interference technology based on G-T (Gires-Tournois) etalon, the technology based on micro electro mechanical systems (MEMS), PLC (Planner Lightwave Circuit) ring resonant cavity and multi-stage dispersion compensation module (DCM) cascade.

For the adaptive dispersion compensation method shown in FIG. 3, the performance detected by the adaptive dispersion compensator can also be residual dispersion, as described in patent WO161889; or the shape of the optical signal, as described in U.S. Pat. No. 6,515,779, U.S. Pat. No. 6,266,170. The deficiency of implementing the adaptive dispersion compensation by detecting residual dispersion is: the technology is complex and the method is hard to implement, and nonlinear effect and the polarization mode dispersion (PMD) can directly affect the precision of dispersion detection; for multi-channel signal, the residual dispersion information of each channel is needed for dispersion adjustment, and the method is relatively complicated; the accuracy of the residual dispersion detection and the detection time directly affect the performance of the adaptive dispersion compensator. The deficiency of implementing the adaptive dispersion compensation by detecting the bit error performance of the system is: the bit error detection relates with the code type and affects the adaptability of the adaptive dispersion compensation system; there are many factors to cause the bit error of the system, the implementation method of adjusting dispersion according to the bit error performance is relatively complicated; during the process of adjusting the adaptive dispersion compensation, usually several adjustments should be performed according to the bit error performance, which increases the time for dispersion adjustment.

Altogether, if adaptive dispersion compensation is implemented by directly detecting the residual dispersion, the effects of non-linear, PMD, and etc. will directly affect the precision of dispersion detection; while the indirect dispersion detection method by applying bit error detection is related to the frame structure applied by the system, and it often needs to be implemented through several adjustments, and the time for dispersion adjustment is relatively long.

### SUMMARY OF THE INVENTION

The technical problem to be solved in the present invention is to offer an apparatus for adaptive dispersion compensation and the method thereof to overcome the deficiency of the prior art, and the apparatus can adaptively compensate dispersion of the system in real time and effectively guarantee the transmission quality of the signal in the system.

The present invention provides an apparatus for adaptive dispersion compensation which is used for adaptive dispersion compensation in the optical communication system, comprising:

input optical fiber, which is used to input optical signal;

an optical tunable dispersion compensator, which is used to optically compensate dispersion of the optical signal from the input optical fiber;

output optical fiber, which is used to output the optical signal whose dispersion is optically compensated;

a signaling system unit, which is used to detect the dispersion performance information in the channel of the optical communication system;

a control logic unit, which is used to calculate the adjustment value of the optical tunable dispersion compensator according to the dispersion performance information detected by the signaling system unit, control the optical tunable dispersion compensator through feedback and adjust the dispersion compensation quantity of the optical dispersion compensator.

The present invention also offers a method for adaptive dispersion compensation to be used to adaptively compensation the dispersion in the optical communication system, comprising the following steps of:

using the optical tunable dispersion compensator to optically compensate the dispersion of the input optical signal and output the compensated optical signal;

detecting the dispersion performance information in the channel of the optical communication system;

calculating the adjustment value of the optical tunable dispersion compensation according to the detected dispersion performance information;

controlling the optical tunable dispersion compensator through feedback according to the adjustment value and adjusting the dispersion compensation quantity of the optical dispersion compensator.

Wherein, said step of detecting dispersion performance is to detect by a distributed system distributed at each node in said optical communication system, with the information exchange among the nodes being performed by a physical channel.

The step of detecting dispersion performance information is to detect the dispersion performance information in the channel based on the performance report offered by each network unit in the optical communication system.

The step of calculating the adjustment value of the optical tunable dispersion compensation comprises: obtaining the dispersion performance information through the signaling transmission among the nodes when the change of the dispersion performance of the channel is detected while the relevant line topology does not change, calculating the adjustment value of the dispersion of the tunable dispersion compensator. The step further comprises: setting the optical dispersion compensator to the corresponding value according to said dispersion adjustment value.

The step of calculating the adjustment value of the optical tunable dispersion compensation includes: originating a signaling to search new route and obtaining the dispersion information through the signaling transmission among the nodes when the changes of the dispersion performance in the channel and the relevant line topology are detected; after a suitable new route is found, calculating the adjustment value of the tunable dispersion compensator based on the obtained dispersion information; the step further includes: while switching the system to the new route, setting the optical dispersion compensator to the corresponding value according to said dispersion adjustment value.

The apparatus for adaptive dispersion compensation and the method thereof of the present invention can be applied in multi-channel or single-channel system to implement adaptive dispersion compensation for multi-channel or single-channel system in the condition that the dispersion of the line or the optical network nodes changes.

### BRIEF DESCRIPTION OF DRAWINGS

FIG. 1 is an illustration of dispersion compensation in the conventional optical communication system;

FIG. 2 is a schematic block diagram of applying the optical tunable dispersion compensator to implement adaptive dispersion compensation;

FIG. 3 is a schematic block diagram of applying the electrical tunable dispersion compensator to implement adaptive dispersion compensation;

FIG. 4 is a schematic block diagram of the apparatus for adaptive dispersion compensation in accordance with an embodiment of the present invention;

FIG. 5 is a block diagram of the position of the apparatus for adaptive dispersion compensation in the optical communication system in accordance with an embodiment of the present invention;

FIG. 6 is a flow chart of the method for adaptive dispersion compensation in accordance with an embodiment of the present invention;

FIG. 7 is a functional block diagram of the apparatus for adaptive dispersion compensation to implement single-channel adaptive dispersion compensation at the receiving side;

FIG. 8 is a functional block diagram of the apparatus for adaptive dispersion compensation to implement multi-channel adaptive dispersion compensation at the receiving side;

FIG. 9 is a functional block diagram of implementing single-channel adaptive dispersion compensation by the apparatus for adaptive dispersion compensation and the measures of electrical dispersion compensation;

FIG. 10 is a functional block diagram of implementing multi-channel adaptive dispersion compensation by the apparatus for adaptive dispersion compensation and the measures of electrical dispersion compensation;

FIG. 11 is an illustration of the increase of the system transmission distance after applying electrical dispersion compensation;

FIG. 12 is a flow chart of implementing adaptive dispersion compensation by the apparatus for adaptive dispersion compensation.

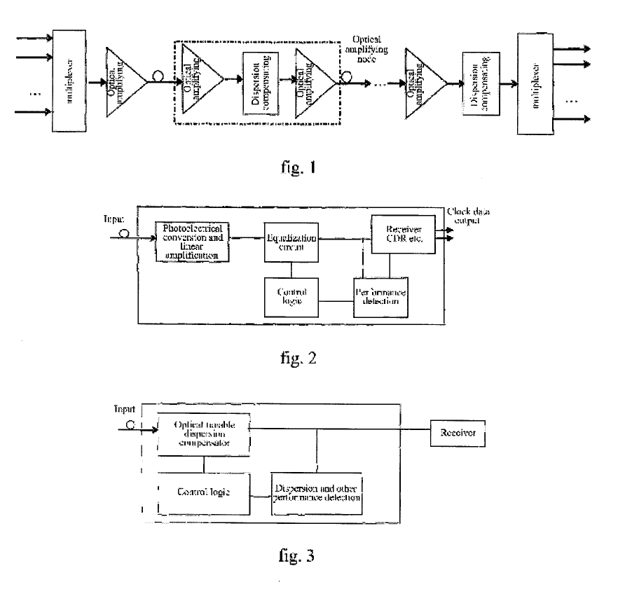

### PREFERRED EMBODIMENT OF THE PRESENT INVENTION

The technical scheme of the present invention and its beneficial effects will become obvious through the detailed description of the preferred embodiments with reference to the accompanying figures.

The core content of the present invention is: apply the signaling system unit to transmit the dispersion of the line or the optical network nodes and its change information (namely, dispersion performance information) in real time, and with this dispersion performance information, the control logic unit applies specified control strategy to calculate the adjustment value of the dispersion compensation, controls the tunable dispersion compensator through feedback, and adjusts the dispersion compensation value, thus achieving the purpose of adaptive dispersion compensation.

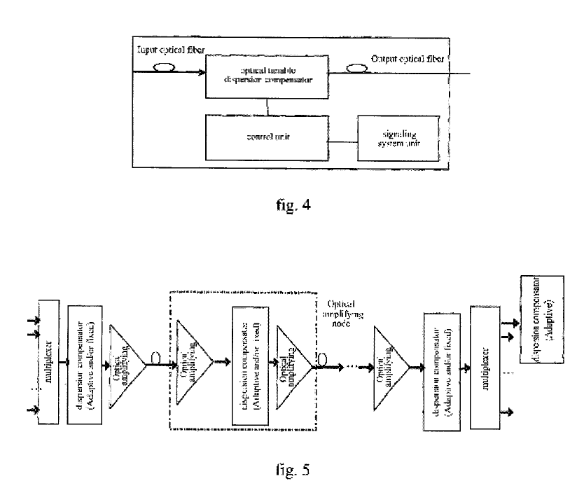

FIG. 4 is a structural block diagram of the apparatus for adaptive dispersion compensation in accordance with the present invention. The apparatus can be applied in single-channel and multi-channel system and comprises five parts: input optical fiber, output optical fiber, optical tunable dispersion compensator, signaling system unit and control logic unit.

In FIG. 4, the input optical fiber is used to input optical signal; the optical tunable dispersion compensator is used to compensate optically the dispersion of the optical signal from the input optical fiber; the output optical fiber is used to output the optical signal for which the optical dispersion compensation is performed; the signaling system unit is used to detect the dispersion performance information in the channel of the optical communication system; the control logic unit is used to calculate the adjustment value of the optical tunable dispersion compensator according to the dispersion performance information detected by the signaling system unit, control the optical tunable dispersion compensator through feedback and adjust the dispersion compensation quantity of the optical dispersion compensator.

The apparatus for adaptive dispersion compensation in accordance with the present invention can be placed at the transmitting side, receiving side of the optical communication system and the line optical amplifying nodes of the system. Wherein:

The control logic unit uses certain control strategy to control the optical tunable dispersion compensator through feedback according to the dispersion and its change information (namely, the dispersion performance information) detected by the signaling system unit, adjusts the dispersion compensation quantity of the optical tunable dispersion compensator until the optical signal channel reaches the optimum dispersion compensation. The strategy for the control logic unit to control the optical tunable dispersion compensator in which the dispersion value to be set for the tunable dispersion compensator is calculated and the adaptive adjustment of the dispersion is realized can use, but not limited to, the following strategy: the residual dispersion of the channel signal after adaptive dispersion compensated is controlled within a certain range.

The signaling system unit can be a distributed system distributed at each node of the system, and the information exchange between the node at which the apparatus for the adaptive dispersion compensation locates and the signal system unit of other each node can be performed through a physical channel.

The signaling system unit detects the optical signal channel from the source node to the terminal node to obtain the dispersion and its change information of each unit in the system, and the information includes, but not limited to, the following information: the dispersion tolerance of the transmitter, the minimal and maximal residual dispersions allowed by the receiver; the increased or decreased dispersion value of the ordinary optical amplifying node (without OXC or ROADM functions); the dispersion value of the optical fiber line; the equivalent dispersion of the non-linear effects of the optical fiber line, which is used to describe the influence caused by non-linear effects such as SPM (Self-phase Modulation) and pulse compression caused by effects such as SPM; the increased or decreased dispersion value of each channel related to the OAD conditions of ROADM optical transport node; the increased or decreased dispersion value of each channel related to the OXC conditions of OXC optical transport node; and other dispersion features of the network nodes or the network units which cause the dispersion change.

The method for the signaling system unit to detect the dispersion performance information can be, but not limited to, the following methods:

The static dispersion information of the network unit, including the dispersion tolerance of the transmitter, the residual dispersion allowed by the receiver, the increased or decreased dispersion value of the ordinary optical amplifying node (without OXC and ROADM functions); the dispersion of the optical fiber line; the equivalent dispersion of the non-linear effect of the optical fiber line, and so on, is reported to the signaling system unit by each network unit according to the pre-set information;

The increased or decreased dispersion value of each channel related to the OAD conditions of the ROADM optical transport node can be the dispersion information in different OAD condition reported by each network unit to the signaling system unit as well as the different pre-set OAD conditions, and the signaling system unit further analyzes to obtain the increased or decreased dispersion value of each channel related to the OAD conditions of ROADM optical transport node;

The increased or decreased dispersion value of each channel related to the OXC conditions of the OXC optical transport node can be the dispersion information in different OXC condition reported by each network unit to the signaling system unit as well as the different pre-set OXC conditions, and the signaling system unit further analyzes to obtain the increased or decreased dispersion value of each channel related to the OXC conditions of OXC optical transport node.

The signaling system unit transmits the dispersion of the channel from the source node to the target node and its change information, and the method for transmitting the information can be, but not limited to, the following methods:

The signaling system unit can originate information transmission when the line topology changes or the dispersion of certain component at the optical network node or the line changes, and through the information exchange among the nodes, transmit the dynamic dispersion performance information of the channel to be controlled in each part of the optical network system to the node at which the apparatus for adaptive dispersion compensation locates and eventually transmit the information to the control logic unit;

The signaling system unit can also timely originate the process of information exchange and timely transmit the dispersion performance information of the channel to be controlled in each part of the optical network system to the node at which the apparatus for adaptive dispersion compensation locates through the information exchange among the nodes and eventually transmit the information to the control logic unit;

The signaling system unit can also originate the process of information transmission at the time of the node initialization, transmit the dispersion performance information of the channel to be controlled in each part of the optical network system to the node at which the apparatus for adaptive dispersion compensation locates through the information exchange among the nodes and transmit the information to the control logic unit;

The method of information transmission for the signaling system unit can be a combination of the above methods.

The optical tunable dispersion compensator can be, but not limited to, the following compensators: various tunable dispersion compensators applying CFBG, interference technology with G-T etalon, MEMS (micro electromechanical system) technology, PLC ring resonate cavity and etc., and also can be the devices applying multi-stage fixed dispersion compensators cascade and using the optical switch to implement different dispersion compensation values, or any other optical devices that can achieve dispersion compensation.

FIG. 5 is a block diagram of the position of the apparatus having the function of adaptive dispersion compensation in the optical communication system. The dispersion compensation of the system is divided into fixed dispersion compensation and optical tunable dispersion compensation. The former is used to statically compensate the dispersion of the line and the latter dynamically compensates the dispersion and further includes optical multi-channel tunable dispersion compensation and single-channel tunable dispersion compensation. As shown in FIG. 5, the optical tunable dispersion compensation is implemented by the adaptive dispersion compensator, which is the apparatus for optical multi-channel tunable dispersion compensation or the optical single-channel tunable dispersion compensation placed at the transmitting side, receiving side of the optical communication system, or the line optical amplifying node of the system.

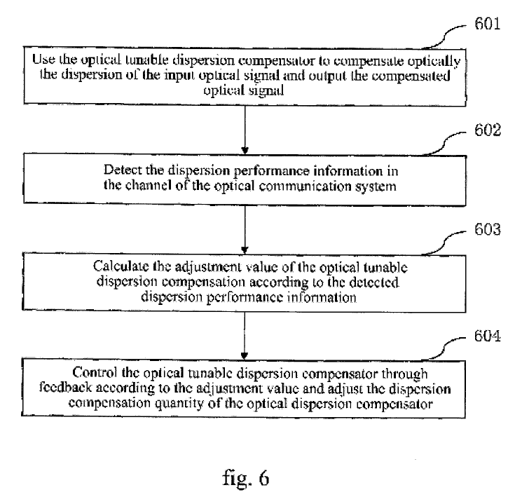

FIG. 6 is a flow chart of adaptively compensating the dispersion in the optical signal channel by the apparatus for adaptive dispersion compensation, comprising:

Step 601: using the optical tunable dispersion compensator to compensate optically the dispersion of the input optical signals and output the compensated optical signals;

Step 602: detecting the dispersion performance information in the channel of the optical communication system;

Step 603: calculating the adjustment value of the optical tunable dispersion compensation according to the detected dispersion performance information;

Step 604: controlling the optical tunable dispersion compensator through feedback and adjusting the dispersion compensation quantity of the optical dispersion compensator based on the adjustment value.

The adaptive dispersion compensation apparatus of the present invention uses the dispersion information obtained by the signaling system unit to control the dispersion compensation quantity of the optical dispersion compensator. Wherein, the signaling system unit dynamically exchanges the dispersion information of each node in the line and the dispersion tolerance information of the optical source, the topology structure of the system, the changes of the transmission path of a certain wavelength or the changes of the dispersion performance of the optical source caused by OADM at the optical wavelength level of the ROADM node in the system, the changes of the transmission path of a certain wavelength or the changes of the dispersion performance of the optical source caused by the optical wavelength level crossconnect of the OXC node. The control logic unit calculates the optimum dispersion compensation quantity of the tunable dispersion compensator according to the information transmitted by the signaling system unit and sets the dispersion compensation value of the optical tunable dispersion compensator as the optimum value.

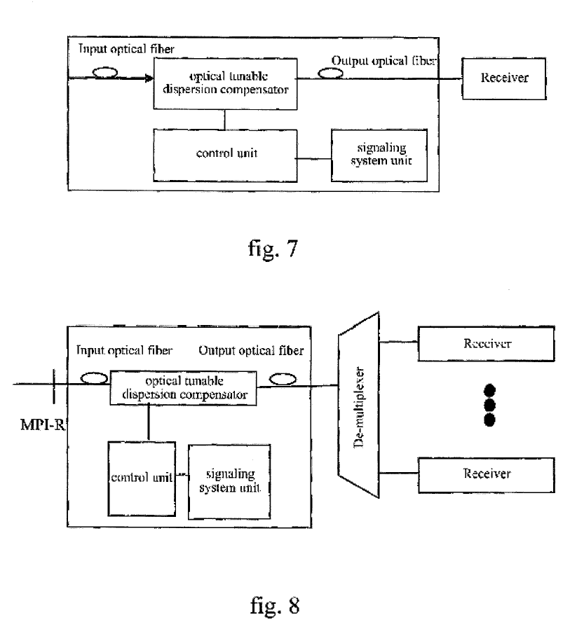

The following figures from FIG. 7 to FIG. 10 are several applications of the apparatus for adaptive dispersion compensation of the present invention in the system:

FIG. 7 is a functional block diagram of the apparatus for adaptive dispersion compensation to implement single-channel adaptive dispersion compensation at the receiving side, which is used to implement the function of single-channel adaptive dispersion compensation;

FIG. 8 is a functional block diagram of the apparatus for adaptive dispersion compensation to implement multi-channel adaptive dispersion compensation at the receiving side, which is used to implement the function of multi-channel adaptive dispersion compensation;

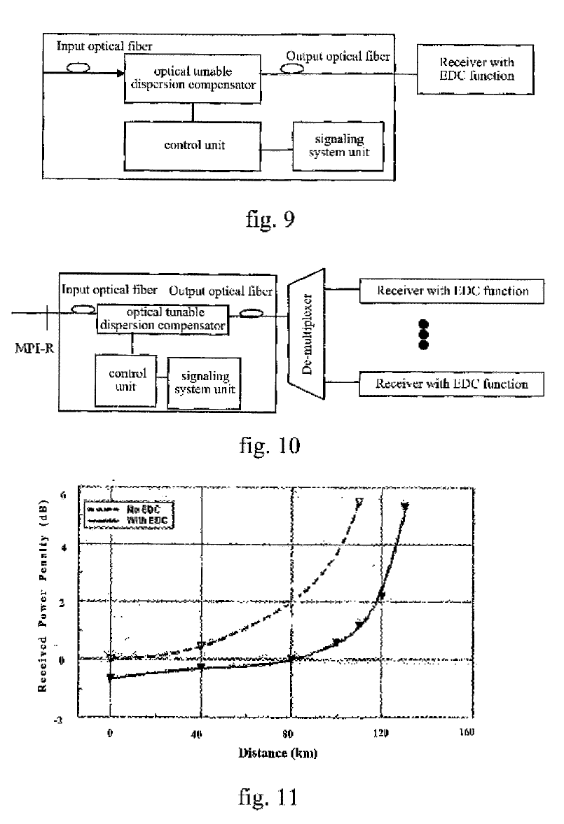

FIG. 9 is a functional block diagram of implementing single-channel adaptive dispersion compensation by the apparatus for adaptive dispersion compensation and the measures of electrical dispersion compensation, which is used to implement the function of single-channel adaptive dispersion compensation; wherein the control of the electrical tunable dispersion compensator is controlled by detecting the performance of the single-channel signal through feedback;

FIG. 10 is a functional block diagram of implementing multi-channel adaptive dispersion compensation by the apparatus for adaptive dispersion compensation and the measures of electrical dispersion compensation, which is used to implement the function of multi-channel adaptive dispersion compensation; wherein the control of the electrical tunable dispersion compensator is controlled by detecting the performance of the single-channel signal through feedback.

The electrical tunable dispersion compensator shown in FIG. 9 and FIG. 10 can be used to expand the receiver's tolerance capacity of the residual dispersion. FIG. 11 is an illustration of applying electrical dispersion compensation measure to extend the transmission distance of the 10 Gb/s system, and it can be seen that for LiNbO3 modulated optical source, the regular optical fiber transmission distance is about 80 km before applying electrical dispersion compensation and extends to 120 km after applying electrical dispersion compensation.

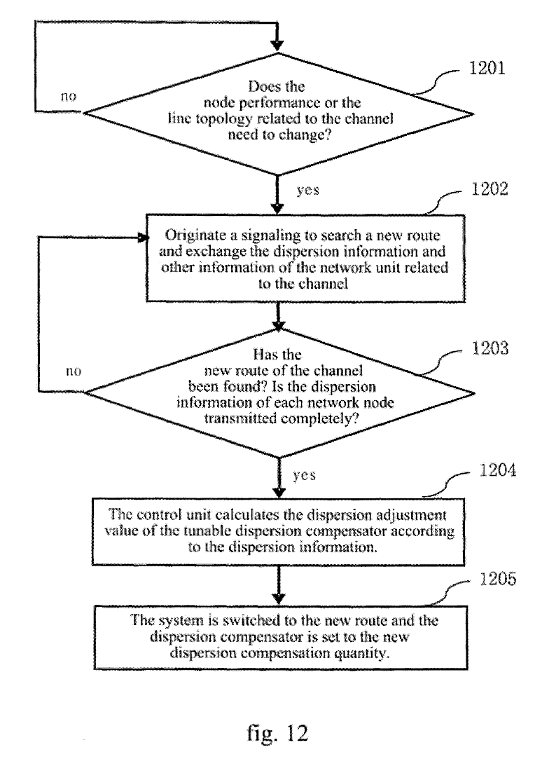

In the practical applications, there are many kinds of processes of adaptive dispersion compensation performed by the adaptive dispersion compensation apparatus of the present invention. FIG. 12 is a flow chart of one of them.

Firstly, each node in the system detects whether the dispersion performance of the node or the line topology related to the channel needs to be changed or not (step 1201).

If only the dispersion performance changes, the signaling system unit originates a signaling and transmits the single dispersion information and other information of the network related to the channel to the controlled node of the adaptive dispersion compensator, calculates the dispersion adjustment value of the tunable dispersion compensator according to the dispersion information and sets the tunable dispersion compensator as the corresponding value when the dispersion information of each network node is exchanged completely;

If the line topology also changes and new route is needed to perform protection switching or restoration, the signaling system initializes the signaling process to search a new route and exchanges the single dispersion information and other information of the network related to the channel to the controlled node of the adaptive dispersion compensator (step 1202).

Whether a new route is found and the dispersion information of each network node is exchanged completely is determined (step 1203).

After the dispersion information of each network node is exchanged completely and a suitable route is found, the dispersion adjustment value of the tunable dispersion compensator is calculated according to the dispersion information (step 1204).

The tunable dispersion compensator is set as the corresponding value while the system is switched to the new route (step 1205).

As mentioned above, the signaling system unit detects and transmits the dispersion and its change of the line and each channel of the system. The dispersion performance of the related components in the optical communication system relates to the channel with corresponding wavelength, and the dispersion performance concludes the following aspects:

dispersion tolerance of the transmitter C_{Tx};

the minimal residual dispersion Cₘᵢₙ and the maximal residual dispersion Cₘₐₓ allowed by the receiver;

dispersion adjustment value of the tunable dispersion compensator C_{adj};

the increased or decreased dispersion value of ordinary optical amplifying node (without OXC or ROADM functions) C_{NEj};

dispersion of the optical fiber line C_{Li}, which is used to describe the dispersion value of the line;

equivalent dispersion of the non-linear effect of the optical fiber line C_{NLi}, which is used to describe the influence caused by the non-linear effect such as SPM; since the pulse compression caused by SPM is similar to the effect caused by dispersion, this item is listed here;

the increased or decreased dispersion value of each channel related to OAD condition of ROADM optical transport node C_{NEj};

the increased or decreased dispersion value of each channel related to OXC condition of OXC optical transport node C_{NEj};

The signaling system unit is a distributed system distributed at each optical network node in the system. The information exchange between the optical network node where the adaptive dispersion compensation apparatus locates and the signaling system unit between each optical network node is performed through a certain physical channel. And there are various physical channels.

The key object of the apparatus and method of the present invention is to feed back the dispersion performance of each part of the system of the channel in which the dispersion changes to the node where the tunable dispersion compensator locates through the information exchange among the nodes when the topology condition of the line changes or the dispersion of some component in the line or the optical network node sub-system changes. The control logic unit applies certain strategy to calculate the dispersion value needed to be set for the tunable dispersion compensator and sets the dispersion compensation value of the tunable dispersion compensator to this optimum position to implement adaptive dispersion adjustment according to the changes of dispersion of each channel in the system and the changes of the dispersion in the line obtained by the signaling system. There are various dispersion compensation strategies for the tunable dispersion compensator, and the simplest one is to adjust the dispersion compensation quantity of the dispersion compensator to control the residual dispersion value C_{residual} of the system for which the dispersion compensation has been performed to a

$${C}_{residual} = {C}_{Tx} - {C}_{adj} - {\sum }_{i}^{ } {C}_{Li} - {\sum }_{i}^{ } {C}_{NLi} - {\sum }_{j}^{ } {C}_{ONj} {C}_{min} \leq {C}_{residual} \leq {C}_{{max}_{o}}$$

It should be understood that while the invention has been described with specific reference to the preferred embodiments, the true scope of the invention should not be limited thereto. Various modifications and alterations can be made by people skilled in the art based on the technical concept of the present invention, and all those modifications and alterations are intended to be included in the protection scope of the appended claims.

### INDUSTRIAL APPLICABILITY

An apparatus for adaptive dispersion compensation and the method thereof in accordance with the present invention can overcome the deficiency of the prior art, adaptively compensate the dispersion of the system in real time, effectively guarantee the transmission quality of the signals in the system, and can be applied to multi-channel or single-channel system to implement their adaptive dispersion compensation in the condition that the dispersion of the line or the nodes in the optical network changes.

What we claim is:

1. An apparatus for adaptive dispersion compensation used for adaptive dispersion compensation in an optical communication system, characterized in that the apparatus comprises:
input optical fiber, which is used to input optical signals;
an optical tunable dispersion compensator, which is used to optically compensate dispersion of the optical signals from the input optical fiber;
output optical fiber, which is used to output the optical signals whose dispersion is optically compensated;
a signaling system unit, which is used to detect dispersion performance information in a channel of said optical communication system;
a control logic unit, which is used to calculate an adjustment value of the optical tunable dispersion compensator according to the dispersion performance information detected by the signaling system unit, control said optical tunable dispersion compensator through feedback and adjust dispersion compensation quantity of said optical tunable dispersion compensator.

2. The apparatus of claim 1, characterized in that said signaling system unit is a distributed system, including several signaling system sub-units distributed at each node of said optical communication system and information exchange among the signaling system sub-units at each node is performed through a physical channel.

3. The apparatus of claim 1, characterized in that the dispersion performance information detected by said signaling system unit in the channel includes the following information or any combination thereof:
dispersion tolerance of a transmitter;
minimal and maximal residual dispersions allowed by a receiver;
increased or decreased dispersion of an ordinary optical amplifying node;
dispersion of optical fiber line;
equivalent dispersion of non-linear effects of the optical fiber line;
increased or decreased dispersion value of each channel related to Optical Add/Drop (OAD) conditions of Reconfigurable Optical Add/Drop Multiplexer (ROADM) optical transport node;
increased or decreased dispersion value of each channel related to Optical Cross Connect (OXC) conditions of Optical Cross Connect (OXC) optical transport node.

4. The apparatus of claim 1, characterized in that said signaling system unit detects the dispersion performance information in the channel according to a performance report offered by each network unit in said optical communication system.

5. The apparatus of claim 1, characterized in that said signaling system unit further exchanges the detected dispersion performance information to said control logic unit.

6. The apparatus of claim 5, characterized in that said signaling system unit exchanges the dispersion performance information of the optical channel to the control logic unit of the node at which the tunable dispersion compensator locates through signaling interaction among nodes when topology condition of a line of said optical communication system changes or dispersion index of a certain component in the line or the optical network node changes.

7. The apparatus of claim 5, characterized in that said signaling system unit timely transmits the dispersion performance information of the optical channel to the control logic unit of the node at which the tunable dispersion compensator locates through the signaling interaction among the nodes.

8. The apparatus of claim 5, characterized in that said signaling system unit send the dispersion performance information of the optical channel to the control logic unit of the node at which the optical tunable dispersion compensator locates through the information exchange among the nodes when the node at which the optical tunable dispersion compensator locates is initializing.

9. The apparatus of claim 1, characterized in that said optical tunable dispersion compensator is a tunable dispersion compensator applying chirped fiber Bragg grating, interference technology with G-T (Gires-Tournois) etalon, micro electromechanical system technology or PLC (Planner Lightwave Circuit) ring resonate cavity technology, or a device applying multi-stage fixed dispersion compensator cascade and using an optical switch to implement different dispersion compensation quantity.

10. A method for adaptive dispersion compensation to be used for adaptive dispersion compensation in an optical communication system, comprising the following steps of:
using an optical tunable dispersion compensator to compensate optically the dispersion of input optical signals and output the compensated optical signals;
detecting dispersion performance information in channel of said optical communication system;
calculating an adjustment value of optical tunable dispersion compensation according to the detected dispersion performance information;
controlling the optical tunable dispersion compensator through feedback according to the adjustment value and adjusting dispersion compensation quantity of said optical tunable dispersion compensator.

11. The method of claim 10, characterized in that said step of detecting dispersion performance is to detect by a distributed system distributed at each node in said optical communication system, and information exchange among the nodes is performed by a physical channel.

12. The method of claim 10, characterized in that said detected dispersion performance information includes the following information or any combination thereof:
dispersion tolerance of a transmitter;
minimal and maximal residual dispersions allowed by a receiver;
increased or decreased dispersion of an ordinary optical amplifying node;
dispersion of optical fiber line;
equivalent dispersion of non-linear effects of the optical fiber line;
increased or decreased dispersion value of each channel related to Optical Add/Drop (OAD) conditions of Reconfigurable Optical Add/Drop Multiplexer (ROADM) optical transport node;
increased or decreased dispersion value of each channel related to Optical Cross Connect (OXC) conditions of Optical Cross Connect (OXC) optical transport node.

13. The method of claim 10, characterized in that said step of detecting dispersion performance information is to detect the dispersion performance information in the channel based on a performance report offered by each network unit in the optical communication system.

14. The method of claim 10, characterized in that:
said step of calculating the adjustment value of the optical tunable dispersion compensation includes: obtaining said dispersion performance information through signaling transmission among the nodes when change of the dispersion performance of the channel is detected while relevant line topology does not change, and calculating the adjustment value of dispersion of the tunable dispersion compensator;
said step of controlling the optical tunable dispersion compensator through feedback includes: setting said optical tunable dispersion compensator to a corresponding value according to said dispersion adjustment value.

15. The method of claim 10, characterized in that:
said step of calculating the adjustment value of the optical tunable dispersion compensation includes: originating a signaling to search a new route and obtaining said dispersion performance information through signaling transmission among the nodes when changes of the dispersion performance in the channel and the relevant line topology are detected;
after a suitable new route is found, calculating the adjustment value of the tunable dispersion compensator based on the obtained dispersion information;
said step of controlling the optical tunable dispersion compensator through feedback includes: setting said optical dispersion compensator to a corresponding value according to said dispersion adjustment value while the system switches to the new route.

16. The apparatus of claim 10, characterized in that said optical tunable dispersion compensator is a tunable dispersion compensator applying chirped fiber Bragg grating, or interference technology with G-T (Gires-Tournois) etalon, or micro electromechanical system technology, or PLC (Planner Lightwave Circuit) ring resonate cavity technology, or a device applying multi-stage fixed dispersion compensator cascade and using an optical switch to implement different dispersion compensation quantity.
